(19) United States
(12) Patent Application Publication
(10) Pub. No.: US 2009/0201275 A1
(43) Pub. Date: Aug. 13, 2009

(54) Gamma voltage generator, method of generating gamma voltage, and organic light emitting display using the same

(76) Inventor: Young-Min Bae, Suwon-si (KR)

Correspondence Address: ROBERT E. BUSHNELL & LAW FIRM, 2029 K STREET NW, SUITE 600, WASHINGTON, DC, 20006-1004, US

(21) Appl. No.: 12/222,051

(22) Filed: Jul. 31, 2008

(30) Foreign Application Priority Data
Feb. 13, 2008 (KR) 10-2008-0013031

(51) Int. Cl. G09G 5/00; G09G 3/30

(52) U.S. Cl. 345/208; 345/76

(57) ABSTRACT

A gamma voltage generator capable of displaying linear gray levels at low gray levels. The gamma voltage generator includes a ladder resistor positioned between an uppermost voltage and a lowermost voltage to output a plurality of voltages, a first gray level voltage selector for outputting one of some voltage values supplied from the ladder resistor to a first gray level voltage, a minimum voltage selector for outputting one of remaining voltage values excluding some voltage values supplied from the ladder resistor as a minimum voltage that displays a brightest gray level, an intermediate voltage selectors for outputting an intermediate gray level voltage using the first gray level voltage and the minimum voltage, and a gray level voltage output unit for generating gamma voltages required for generation of data signals using the first gray level voltage, the minimum voltage, and the intermediate gray level voltages.

### CLAIM OF PRIORITY

This application makes reference to, incorporates the same herein, and claims all benefits accruing under 35 U.S.C. §119 from an application for GAMMA VOLTAGE GENERATOR, METHOD OF GENERATING GAMMA VOLTAGE, AND ORGANIC LIGHT EMITTING DISPLAY USING THE SAME earlier filed in the Korean Intellectual Property Office on 13 Feb. 2008 and there duly assigned Serial No. 10-2007-0013031.

### BACKGROUND OF THE INVENTION

1. Field of the Invention

The present invention relates to a gamma voltage generator, a method of generating a gamma voltage, and an organic light emitting display, and more particularly, to a gamma voltage generator capable of displaying linear gray levels in low gray levels, a method of generating a gamma voltage, and an organic light emitting display using the same.

2. Description of the Related Art

Recently, various flat panel displays (FPD) capable of reducing weight and volume that are characteristics found unfavorable in cathode ray tubes (CRTs) have been developed. The FPDs include liquid crystal displays (LCDs), field emission displays (FEDs), plasma display panels (PDPs), and organic light emitting displays.

Among the FPDs, the organic light emitting displays display images using organic light emitting diodes (OLED) that generate light by re-combination of electrons and holes. The organic light emitting display has high response speed and is driven with low power consumption.

The organic light emitting display selects one of a plurality of gamma voltages supplied from a gamma voltage generator in response to data as a data signal and supplies the selected data signal to pixels to display an image.

FIG. 1 schematically illustrates a contemporary gamma voltage generator. In FIG. 1, for convenience sake, a gamma voltage generator which displays 64 gray levels is illustrated.

Referring to FIG. 1, the contemporary gamma voltage generator includes a ladder resistor 2. The ladder resistor 2 determines an uppermost voltage VHI supplied from the outside as a reference voltage and includes a plurality of resistors serially coupled between a lowermost voltage VLO and the uppermost voltage VHI.

The ladder resistor 2 extracts a plurality of gray level voltages V0, V4, V10, V21, V42, and V63 between the uppermost voltage VHI and the lowermost voltage VLO. The plurality of gray level voltages V0, V4, V10, V21, V42, and V63 extracted from the ladder resistor 2 are divided into voltages of V0, V1, V2, V3, V4, V5, . . . , and V63 by a gray level voltage output unit (not shown) to be supplied to a data driver as a gamma voltage. The data driver supplies one voltage among gamma voltages of V0 to V63 to pixels as the data signal in response to the data.

However, the contemporary gamma voltage generator has a problem in that the linear gray levels are not displayed at the low gray levels. To be specific, the voltage of V0 is used to display black in pixels. Therefore, a desired black color can be displayed when the voltage of V0 is set to be as high as possible. However, when the voltage of V0 is set as a high voltage, a large voltage difference is generated between a voltage V4 and a voltage V0 so that an image with desired brightness is not displayed at the low gray levels. Actually, in the contemporary gamma voltage generator, as illustrated in FIG. 2, a large voltage difference is generated between the voltage V0 and the voltage V4. Therefore, the linear gray levels cannot be displayed at the low gray levels.

The above information disclosed in this Description of the Related Art section is only for enhancement of understanding of the background of the invention and therefore it may contain information that does not form the prior art that is already known to a person of ordinary skill in the art.

### SUMMARY OF THE INVENTION

Accordingly, it is an object of the present invention to provide a gamma voltage generator capable of displaying linear gray levels at low gray levels in an organic light emitting display using the same.

In order to achieve the foregoing and/or other objects of the present invention, a gamma voltage generator, comprises a ladder resistor positioned between an uppermost voltage and a lowermost voltage to output a plurality of voltages, a first gray level voltage selector for outputting one of some voltage values supplied from the ladder resistor to a first gray level voltage, a minimum voltage selector for outputting one of remaining voltage values excluding some voltage values supplied from the ladder resistor as a minimum voltage that displays a brightest gray level, an intermediate voltage selectors for outputting an intermediate gray level voltage using the first gray level voltage and the minimum voltage, and a gray level voltage output unit for generating gamma voltages required for generation of data signals using the first gray level voltage, the minimum voltage, and the intermediate gray level voltages. The uppermost voltage is output as a gamma voltage of an uppermost gray level that displays black in a pixel.

The gamma generator further comprises an amplitude control register for controlling the first gray level voltage selector and the minimum voltage selector and a curve control register for controlling the intermediate voltage selectors. The intermediate voltage selectors receive at least two voltages among the first gray level voltage, the minimum voltage, and the intermediate gray level voltage to divide the received voltages into a plurality of voltages and outputs one of the plurality of divided voltages as the intermediate gray level voltage.

An organic light emitting display comprises a plurality of pixels arranged in a matrix between scan lines and data lines, a scan driver for supplying scan signals to the scan lines, a data driver for supplying data signals to the data lines, and at least one gamma voltage generator for supplying gamma voltages to the data driver. The gamma voltage generator comprises a ladder resistor positioned between an uppermost voltage and a lowermost voltage to output a plurality of voltages, a first gray level voltage selector for outputting one of partial voltage values supplied from the ladder resistor to a first gray level voltage, a minimum voltage selector for outputting one of remaining voltage values excluding the partial voltage values supplied from the ladder resistor as a minimum voltage that displays a brightest gray level, an intermediate voltage selectors for outputting an intermediate gray level voltage using the first gray level voltage and the minimum voltage, and a gray level voltage output unit for generating gamma voltages required for generation of data signals using the first gray level voltage, the minimum voltage, and the intermediate gray level voltages. The uppermost voltage is output as a gamma voltage of an uppermost gray level that displays black in a pixel. The pixels are divided into red pixels, green pixels, and blue pixels and the gamma voltage generator comprises a red gamma voltage generator for supplying gamma voltages corresponding to the red pixels, a green gamma voltage generator for supplying gamma voltages corresponding to the green pixels, and a blue gamma voltage generator for supplying gamma voltages corresponding to the blue pixels.

A method of generating gamma voltages comprises dividing an uppermost voltage and a lowermost voltage into a plurality of voltages, generating intermediate gray level voltages including a first gray level voltage and a minimum voltage using the divided voltages, and dividing the first gray level voltage, the minimum voltage, and the intermediate gray level voltages to generate a plurality of gamma voltages. The uppermost voltage is set as a gamma voltage that displays black.

The minimum voltage is a gamma voltage corresponding to a brightest gray level.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicated the same or similar components, wherein:

FIG. 1 schematically illustrates a contemporary gamma voltage generator;

FIG. 2 is a graph illustrating a gamma voltage generated by the gamma voltage generator illustrated in FIG. 1;

FIG. 3 illustrates an organic light emitting display according to an embodiment of the present invention;

FIG. 4 illustrates a gamma voltage generator illustrated in FIG. 3 according to an embodiment of the present invention;

FIG. 5 is a graph illustrating a gamma voltage generated by the gamma voltage generator illustrated in FIG. 4.

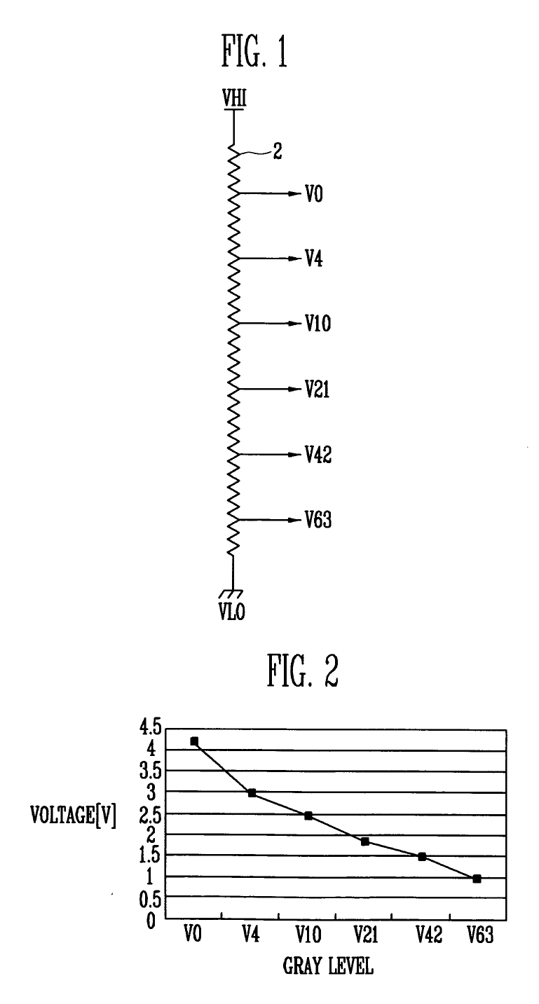

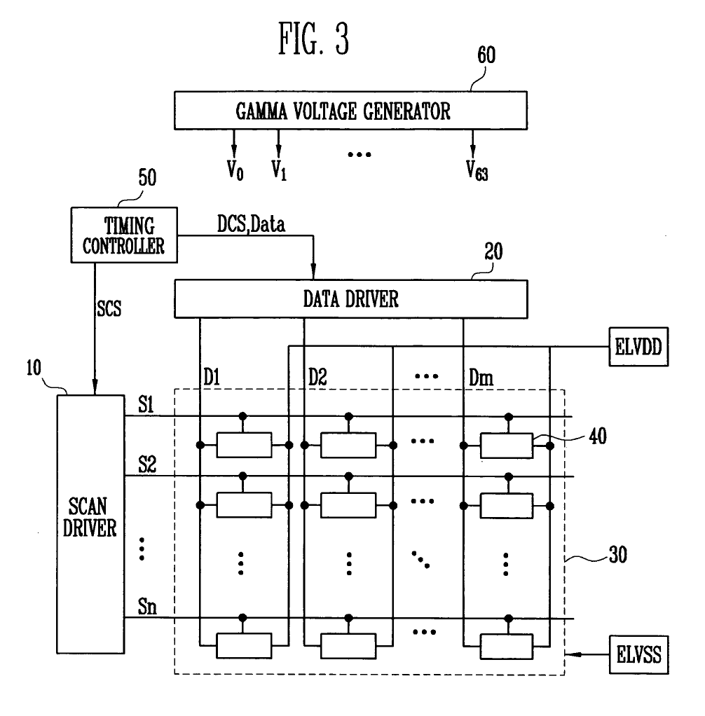

### DETAILED DESCRIPTION OF THE INVENTION

Hereinafter, certain exemplary embodiments according to the present invention will be described with reference to the accompanying drawings. Here, when a first element is described as being coupled to a second element, the first element may be not only directly coupled to the second element but may also be indirectly coupled to the second element via a third element. Further, some of the elements that are not essential to the complete understanding of the invention are omitted for clarity. Also, like reference numerals refer to like elements throughout.

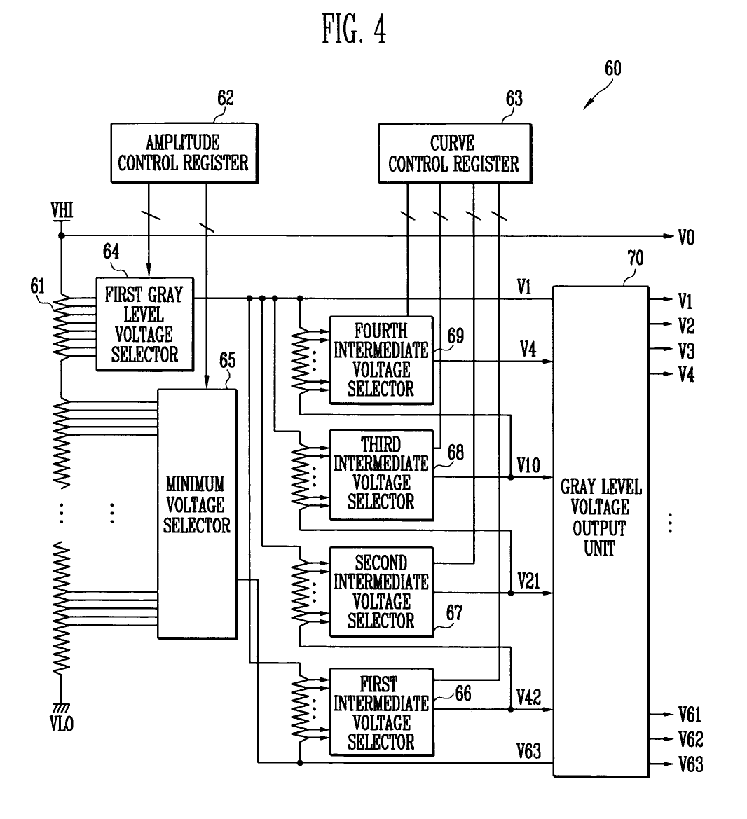

FIG. 3 illustrates an organic light emitting display according to an embodiment of the present invention.

Referring to FIG. 3, the organic light emitting display according to an embodiment of the present includes a pixel unit 30 including a plurality of pixels 40 coupled to scan lines S1 to Sn and data lines D1 to Dm, a scan driver 10 for driving the scan lines S1 to Sn, a data driver 20 for driving the data lines D1 to Dm, a timing controller 50 for controlling the scan driver 10 and the data driver 20, and a gamma voltage generator 60 for generating a gamma voltage.

The timing controller 50 generates data driving control signals DCS and scan driving control signals SCS in response to synchronizing signals supplied from the outside. The data driving control signals DCS generated by the timing controller 50 are supplied to the data driver 20 and the scan driving control signals SCS are supplied to the scan driver 10. The timing controller 50 supplies data supplied from the outside to the data driver 20.

The scan driver 10 sequentially supplies the scan signals to the scan lines S1 to Sn. Actually, the scan driver 10 supplies the scan signals to one of the scan lines S1 to Sn every horizontal period to select the pixels 40.

The gamma voltage generator 60 generates predetermined gamma voltages V0 to V63 to be supplied to V63 to the data driver 20. In FIG. 3, for convenience sake, it is illustrated that the gamma voltages of V0 to V63 are generated by the gamma voltage generator 60. However, the present invention is not limited to the above. Actually, the number of gamma voltages V0 to V63 generated by the gamma voltage generator 60 can vary to correspond to the number of bits of the data Data. It is illustrated that the gamma voltage generator 60 is positioned outside the data driver 20. However, the gamma voltage generator 60 can be provided in the data driver 20.

The data driver 20 receives m data Data from the timing controller 50. The data receiver 20 having received the m data Data selects one of the gamma voltages V0 to V63 to correspond to the bits of the data Data to generate data signals. The data signals generated by the data driver 20 are supplied to the data lines D1 to Dm every horizontal period.

The pixel unit 30 receives a first power source ELVDD and a second power source ELVSS from the outside to supply the first power source ELVDD and the second power source ELVSS to the pixels 40. The pixels having received the first power source ELVDD and the second power source ELVSS display an image with predetermined brightness to correspond to the data signals.

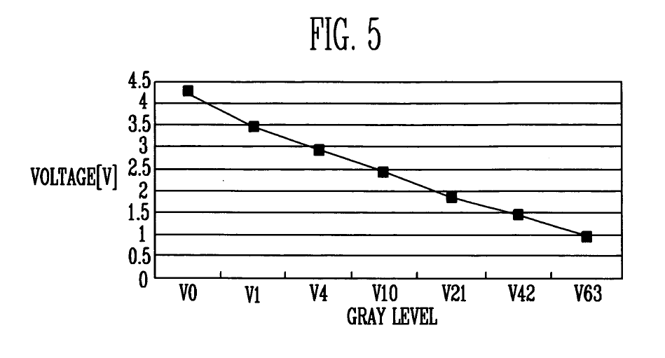

FIG. 4 illustrates a gamma voltage generator according to an embodiment of the present invention illustrated in FIG. 3.

Referring to FIG. 4, a gamma voltage generator 60 according to an embodiment of the present invention includes a ladder resistor 61, an amplitude control register 62, a curve control register 63, a first gray level voltage selector 64, a minimum voltage selector 65, first to fourth intermediate voltage selectors 66 to 69, and a gray level voltage output unit 70.

The ladder resistor 61 determines the uppermost voltage VHI supplied from the outside as a reference voltage and includes a plurality of resistors serially coupled between the lowermost voltage VLO and the uppermost voltage VHI.

Here, when the resistance value of the ladder resistor 61 is set to be small, an amplitude control range is reduced, whereas a correction precision degree is increased. On the other hand, when the resistance value of the ladder resistor 61 is set to be large, the amplitude control range is increased, whereas the correction precision is reduced.

The amplitude control register 62 supplies data for determining the values of a first gray level voltage V1 and a minimum voltage V63 to the first gray level voltage selector 64 and the minimum voltage selector 65.

For example, the amplitude control register 62 receives data of 10 bits to supply the uppermost data of 3 bits to the first gray level voltage selector 64 and to supply the remaining data of 7 bits to the minimum voltage selector 65. That is, the amplitude control register 62 selects the first gray level voltage V1 and the minimum voltage V63 from a plurality of voltages to correspond to the resolution and inch of a panel.

Here, the minimum voltage V63 is a gamma voltage corresponding to the brightest gray level when an image is displayed and the first gray level voltage V1 is a gamma voltage corresponding to the gray level of “1”.

The first gray level voltage selector 64 outputs one of the plurality of voltages distributed by the ladder resistor 61 to the first gray level voltage V1 to correspond to the data supplied from the amplitude control register 62.

The minimum voltage selector 65 outputs one of the plurality of voltages distributed through the ladder resistor 61 to the minimum voltage V63 to correspond to the data supplied from the amplitude control register 62.

The curve control register 63 outputs gamma data that can optimize the display characteristic of the pixel unit 30 to the plurality of intermediate voltage selectors 66 to 69. For example, the curve control register 63 receives data of 16 bits to supply data of 4 bits to the first to fourth intermediate voltage selectors 66 to 69. At this time, an intermediate gray level voltage that can be selected using the data of 16 bits can be controlled.

The first to fourth intermediate voltage selectors 66 to 69 select intermediate voltages corresponding to inflection points at which a slope changes in a gamma curve in response to the gamma data supplied from the curve control register 63. Therefore, the number of intermediate voltage selectors 66 to 69 can be set to be equal to the number of inflection points of the gamma curve that represents the optimal display characteristic of the pixel unit 40.

The first intermediate voltage selector 66 distributes voltages between the first gray level voltage V1 output from the first gray level voltage selector 64 and the minimum voltage V63 output from the minimum voltage selector 65 using a plurality of columns of resistors and selects a gray level voltage V42 in response to the data supplied from the curve control register 63 to output the gray level voltage.

The second intermediate voltage selector 67 distributes voltages between the first gray level voltage V1 output from the first gray level voltage selector 64 and the gray level voltage V42 output from the first intermediate voltage selector 66 using a plurality of columns of resistors and selects a gray level voltage V21 in response to the data supplied from the curve control register 63 to output the gray level voltage.

The third intermediate voltage selector 68 distributes voltages between the first gray level voltage V1 output from the first gray level voltage selector 64 and the gray level voltage V21 output from the second intermediate voltage selector 67 using a plurality of columns of resistors and selects a gray level voltage V10 in response to the data supplied from the curve control register 63 to output the gray level voltage.

The fourth intermediate voltage selector 69 distributes voltages between the first gray level voltage V1 output from the first gray level voltage selector 64 and the gray level voltage V10 output from the third intermediate voltage selector 68 using a plurality of columns of resistors and selects a gray level voltage V4 in response to the data supplied from the curve control register 63 to output the gray level voltage.

The gray level voltage output unit 70 receives the first gray level voltage V1, the intermediate gray level voltages V4, V10, V21, and V42, and the minimum voltage V63 to generate the plurality of gray level voltages V1 to V63 and to supply the generated gray level voltages to the data driver 20 as gamma voltages. For convenience sake, in FIG. 4, the outputs of the gamma voltages corresponding to the 64 gray levels are illustrated.

In detail, the gray level voltage output unit 70 receives the first gray level voltage V1, the intermediate gray level voltages V4, V10, V21, and V42, and the minimum voltage V63 and generates the plurality of gray level voltages V1 to V63 (that is, gamma voltages) having a linear relationship in two intermediate voltage ranges. The gray level voltage output unit 70 can be easily constituted by serially coupling resistors having the same resistance value. However, the present invention is not limited to the above.

On the other hand, according to the present invention, the uppermost voltage VHI is output as the voltage of the uppermost gray level V0 (that is, the gray level of “0”) that displays black. As described above, when the uppermost voltage VHI is used as the voltage of the uppermost gray level V0 that displays black, black with desired brightness can be displayed. That is, when the voltage of the uppermost gray level V0 is output from the gray level voltage output unit 70, a high voltage cannot be assigned to the uppermost gray level V0 in consideration of the voltages of V1, V2, and V3 so that black with desired brightness cannot be displayed.

In addition, according to the present invention, since the voltage of the upper most gray level V0 is generated without passing through the gray level voltage output unit 70, the linear gray levels can be displayed at the low gray levels. To be specific, since the first gray level voltage V1 output from the first gray level voltage selector 64 does not display black, a voltage can be set in consideration of a gray level to be displayed. Actually, in the gamma voltage generator 60 according to the present invention, as illustrated in FIG. 5, the linear gray levels can be displayed at the low gray levels.

Meanwhile although one gamma voltage generator 60 is illustrated in FIGS. 3 and 4, the present invention is not limited to the above. In the organic light emitting display according to an embodiment of the present invention, in order to generate gray level voltages supplied to red, green, and blue pixels in consideration of the characteristics of the OLEDs included in the red, green, and blue pixels, a red gamma voltage generator, a green gamma voltage generator, and a blue gamma voltage generator can be included.

In the gamma voltage generator according to the present invention, the method of generating the gamma voltage, and the organic light emitting display using the same, since the uppermost voltage supplied from the outside is used as the gray level voltage of V0 for displaying black, black with desired brightness can be displayed. In addition, according to the present invention, since the gamma voltages at low gray levels are generated using the first gray level voltage V1 regardless of black, the linear gray levels can be displayed at the low gray levels.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. A gamma voltage generator, comprising:
a ladder resistor positioned between an uppermost voltage and a lowermost voltage to output a plurality of voltages;
a first gray level voltage selector outputting one of some voltage values supplied from the ladder resistor to a first gray level voltage;
a minimum voltage selector outputting one of remaining voltage values excluding some voltage values supplied from the ladder resistor as a minimum voltage that displays a brightest gray level;
an intermediate voltage selectors outputting an intermediate gray level voltage using the first gray level voltage and the minimum voltage; and
a gray level voltage output unit generating gamma voltages required for generation of data signals using the first gray level voltage, the minimum voltage, and the intermediate gray level voltages,
wherein the uppermost voltage is output as a gamma voltage of an uppermost gray level that displays black in a pixel.

2. The gamma generator as claimed in claim 1, further comprising:
an amplitude control register controlling the first gray level voltage selector and the minimum voltage selector; and
a curve control register controlling the intermediate voltage selectors.

3. The gamma voltage generator as claimed in claim 1, wherein the intermediate voltage selectors receive at least two voltages among the first gray level voltage, the minimum voltage, and the intermediate gray level voltage to divide the received voltages into a plurality of voltages and outputs one of the plurality of divided voltages as the intermediate gray level voltage.

4. An organic light emitting display, comprising:
a plurality of pixels arranged in a matrix between scan lines and data lines;
a scan driver supplying scan signals to the scan lines;
a data driver supplying data signals to the data lines; and
at least one gamma voltage generator supplying gamma voltages to the data driver,
wherein the gamma voltage generator comprises:
a ladder resistor positioned between an uppermost voltage and a lowermost voltage to output a plurality of voltages;
a first gray level voltage selector outputting one of some voltage values supplied from the ladder resistor to a first gray level voltage;
a minimum voltage selector outputting one of remaining voltage values excluding some voltage values supplied from the ladder resistor as a minimum voltage that displays a brightest gray level;
an intermediate voltage selectors outputting an intermediate gray level voltage using the first gray level voltage and the minimum voltage; and
a gray level voltage output unit generating gamma voltages required for generation of data signals using the first gray level voltage, the minimum voltage, and the intermediate gray level voltages,
wherein the uppermost voltage is output as a gamma voltage of an uppermost gray level that displays black in a pixel.

5. The organic light emitting display as claimed in claim 4,
wherein the pixels are divided into red pixels, green pixels, and blue pixels, and
wherein the gamma voltage generator comprises:
a red gamma voltage generator supplying gamma voltages corresponding to the red pixels;
a green gamma voltage generator supplying gamma voltages corresponding to the green pixels; and
a blue gamma voltage generator supplying gamma voltages corresponding to the blue pixels.

6. A method of generating gamma voltages, comprising:
dividing an uppermost voltage and a lowermost voltage into a plurality of voltages;
generating intermediate gray level voltages including a first gray level voltage and a minimum voltage using the divided voltages; and
dividing the first gray level voltage, the minimum voltage, and the intermediate gray level voltages to generate a plurality of gamma voltages,
wherein the uppermost voltage is set as a gamma voltage that displays black.

7. The method as claimed in claim 6, wherein the minimum voltage is a gamma voltage corresponding to a brightest gray level.

8. A gamma voltage generator, comprising:
a ladder resistor positioned between an uppermost voltage and a lowermost voltage to output a plurality of voltages;
a plurality of gray level voltage selectors outputting a plurality of voltage values supplied from the ladder resistor to generate a first gray level voltage, a minimum voltage that displays a brightest gray level and an intermediate gray level voltage based on the first gray level voltage and the minimum voltage to generate an intermediate gray level; and
a gray level voltage output unit generating gamma voltages required for generation of data signals using the first gray level voltage, the minimum voltage, and the intermediate gray level voltages,
wherein said uppermost voltage of the plurality of voltages is output as a gamma voltage of an uppermost gray level that displays as black in a pixel,
wherein said brightest gray level, said intermediate gray level and said uppermost gray level form a linear gray level scale.
